(19) United States
(12) Patent Application Publication
(10) Pub. No.: US 2005/0214136 A1
(43) Pub. Date: Sep. 29, 2005

(54) Air compressor

(76) Inventor: Chung-Sheng Tsai, Taiping City (TW)

Correspondence Address: LEONG C LEI, PMB # 1008, 1867 YGNACIO VALLEY ROAD, WALNUT CREEK, CA, 94598, US

(21) Appl. No.: 10/807,126

(22) Filed: Mar. 24, 2004

(51) Int. Cl. F02G 3/00

(52) U.S. Cl. 417/410.1

(57) ABSTRACT

An air compressor for field use comprised of an interlayer in a knapsack to segregate an upper chamber and a lower chamber, both zipped, the upper chamber accommodating multiple components including DC motor, air cylinder, air storage flask, pressure switch and fast connector; a through hole being disposed on the side of the upper chamber to expose the fast connector to plug into an air delivery hose from a pneumatic tool; the lower chamber accommodating the battery and the control box; a see-through window being sewn on the side of the lower chamber; handler, carrying belt and shoulder belt being provided to the knapsack.

### BACKGROUND OF THE INVENTION

(a) Technical Field of the Invention

The present invention is related to a structural configuration of an air compressor, and more particularly, to an improved air compressor that is portable to allow filed operation.

(b) Description of the Prior Art

As illustrated in FIG. 1 of the accompanying drawings for the prior art, a compressor (12) operating on AC power is adapted to the top of an air storage tank, meaning an AC power source must be available in the vicinity of the work place. Though it is not very difficult to have power supply as a fixed power socket is available in the room where the work is provided in a fixed place, it usually takes a length extension wire that may make the process of work awkward. Whereas the use of high pressure air is not limited to a fixed work place, there are many occasions the work is done in a rather stranger place, namely, deflation for motor vehicles, removal of a tire using a power tool kit, delivery of high pressure air into a building provided AC to drive a power hammer in an interior decoration job site. While hunting for power source everywhere, it has to compromise to the source or the work object resulting in poor work efficiency.

### SUMMARY OF THE INVENTION

The primary purpose of the present invention is to provide an improved structural configuration of an air compressor that is portable for field operation. To achieve the purpose, members including components, battery and control box of the air compressor are packed in a knapsack for filed operation.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a front view of a combination of the prior art.

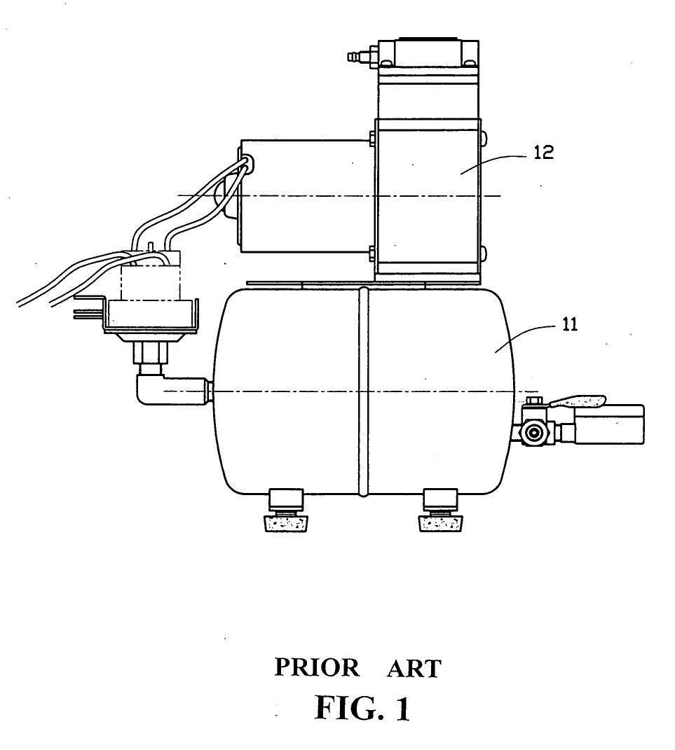

FIG. 2 is a schematic view showing the layout inside a knapsack of the present invention.

FIG. 3 is a perspective view showing components, battery and control box of an air compressor of the present invention.

FIG. 4 is a perspective view showing the appearance of the present invention.

FIG. 5 is another perspective view showing the appearance of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

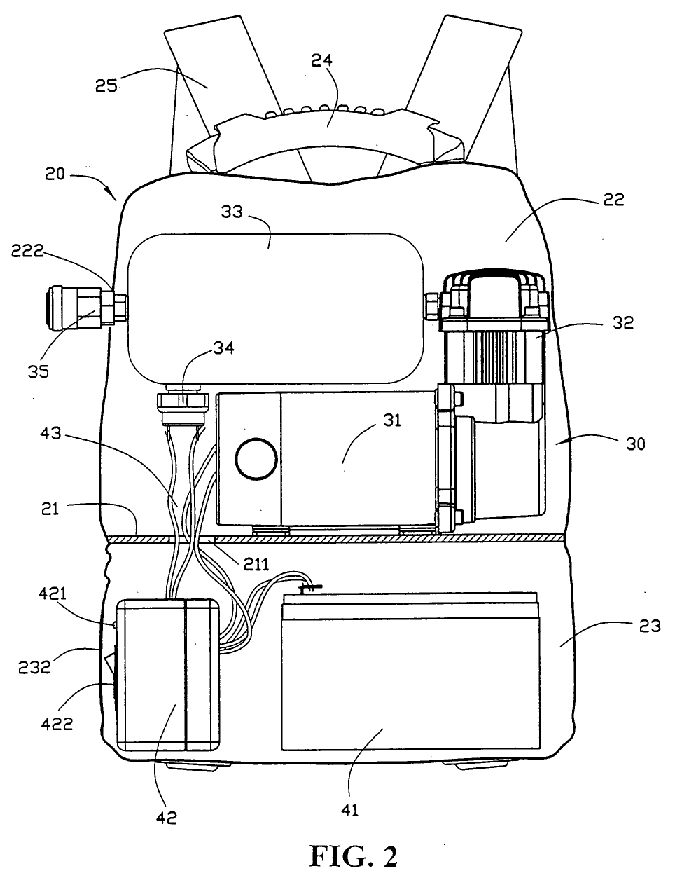

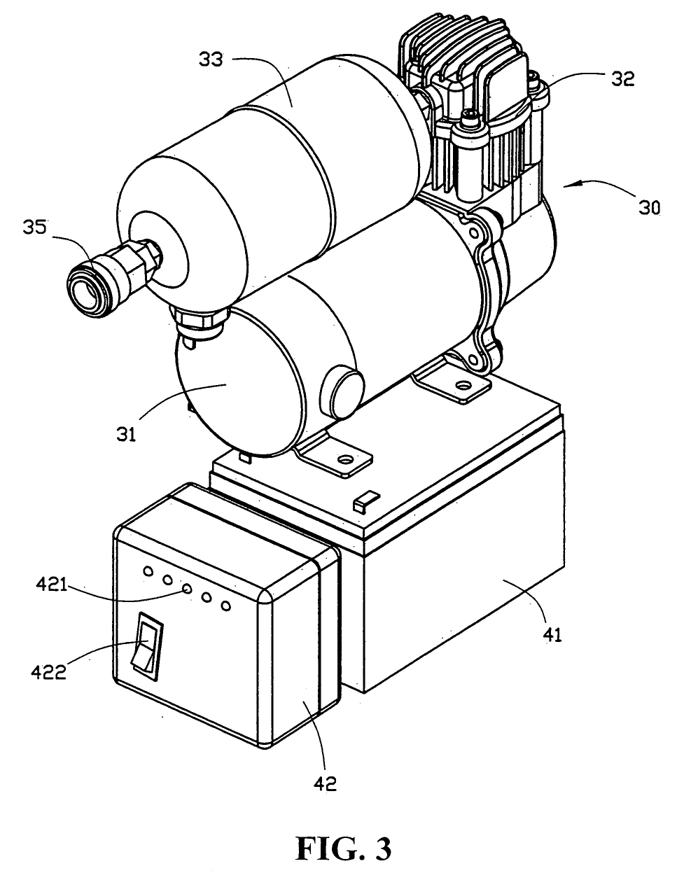

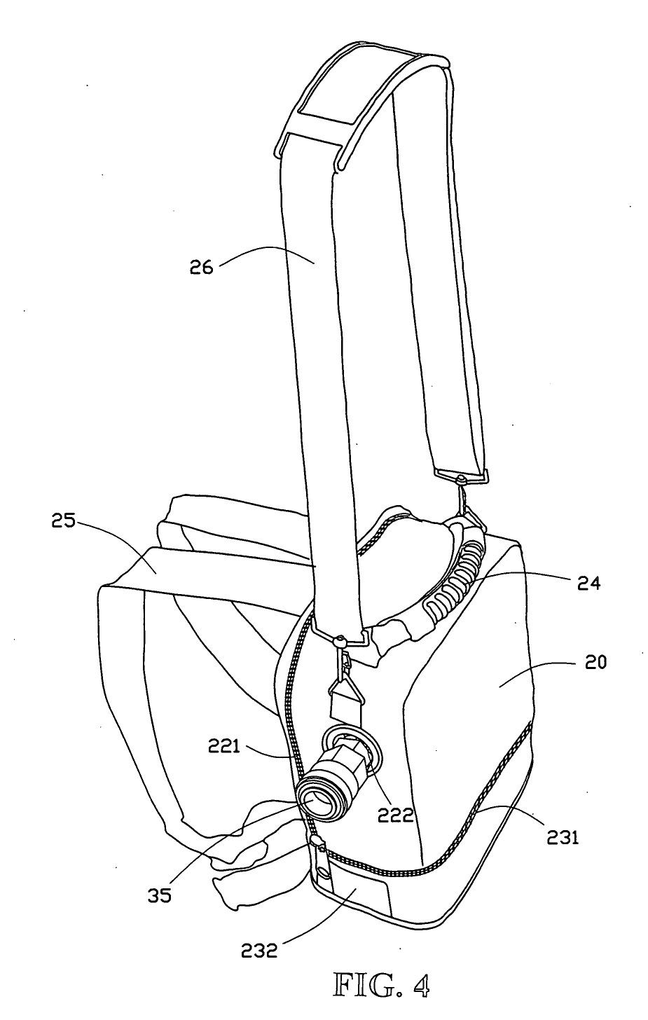

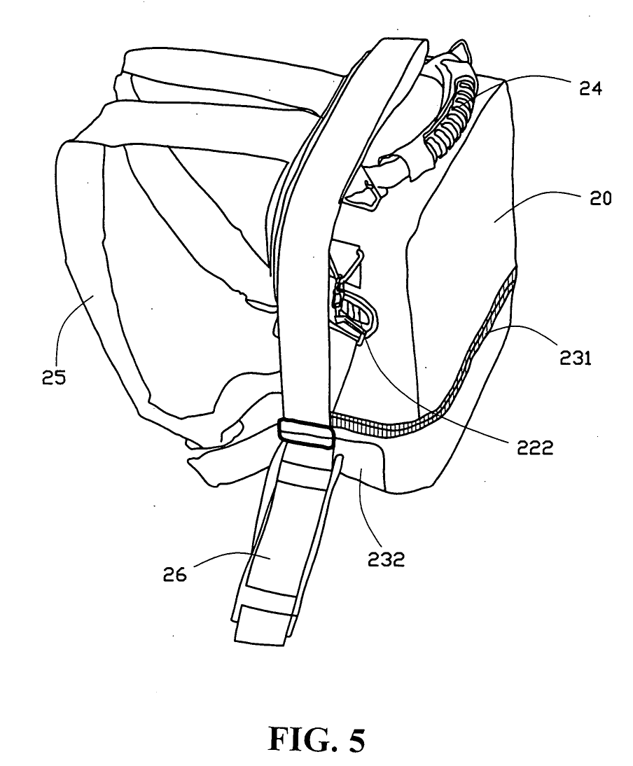

Referring to FIGS. 2 through 5, a preferred embodiment of an improved air compressor of the present invention is essentially comprised of an interlayer (21) provided with a through hole (211) inside a knapsack (20), an upper chamber (22) sewn with a longitudinal zipper (221) to its peripheral and a lower chamber (23) sewn with a lateral zipper (231) with both chambers 22, 23 segregated by the interlayer (21).

The upper chamber (22) accommodates components (30) including a DC motor (31), an air cylinder (30), an air storage flask (33), a pressure switch (34) and a fast connector (35) of the air compressor. Another through hole (222) is provided closer to the side of the fast connector (33) of the air storage flask (33) in the upper chamber (22) to allow the fast connector (35) to expose out of the through hole (222) to plug in an air delivery hose from a pneumatic tool.

The lower chamber (23) of the knapsack (20) is provided to accommodate a battery (41) and a control box (42); a see-through window (232) is sewn o the side of the lower chamber (23) at where close to the control box (42) and a handle (24), a carrying belt (25), and a shoulder belt (26) are provided with the knapsack (20).

The DC motor (35) provides the drive power for those components (30) of the air compressor.

The air storage flask (33) is provided for the storage of the high-pressure air pumped out of those components (30) of the air compressor.

The control box (42) is disposed on its front multiple LEDs (421) and a switch (422) with the former to display the charging capacity and residual power in the battery (41).

The battery (41) is recharged by having an AC power plugged to the control box (42) to store and supply power to the AC motor (31) of those components (30) of the air compressor.

A power wire (43) connecting the DC motor (31) in the upper chamber (22), and the control box (42) and the battery (41) in the lower chamber (23) is admitted from the through hole (211) provided on the interlayer (21).

The improved structural configuration of the air compressor by charging the battery (41) from an AC source allows the air compressor to be carried for filed operation, or at a work place where city power has not yet been provided.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. An improved structural configuration of an air compressor, essentially comprised of an interlayer in a knapsack; an upper chamber and a lower chamber segregated by the interlay; the upper chamber being sewn a longitudinal zipper on its peripheral; the lower chamber being sewn with a lateral zipper, the upper chamber accommodating multiple components of the air compressor including DC motor, air cylinder, air storage flask, pressure switch and fast connector; a through hole being disposed on the side of the upper chamber at where close to the fast connector of the air storage flask to expose the fast connector to plug into an air delivery hose from a pneumatic tool; the lower chamber accommodating the battery and the control box; a see-through window being sewn on the side of the lower chamber at where close to the control box; handler, carrying belt and shoulder belt being provided to the knapsack is characterized by having the battery charged with AC power for field use of the air compressor.

2. An improved structural configuration of an air compressor as claimed in claim 1, wherein the drive power source for those air compressor components relates to an AC motor.

3. An improved structural configuration of an air compressor as claimed in claim 1, wherein, the air storage flask is used to store high pressure pumped by those air compressor components.

4. An improved structural configuration of an air compressor as claimed in claim 1, wherein, multiple LEDs and a switch are provided on the front of the control box with those LEDs to display charging capacity and residual capacity of the battery.

5. An improved structural configuration of an air compressor as claimed in claim 1, wherein, the battery is recharged by having an AC source plugged to the control box to store power to be supplied to the DC motor of those air compressor components.

6. An improved structural configuration of an air compressor as claimed in claim 1, wherein, the wire connecting the DC motor in the upper chamber, and the control box and the battery in the lower chamber penetrates through the through hole disposed on the interlayer in the knapsack.
